(19) United States
(12) Patent Application Publication
(10) Pub. No.: US 2003/0096158 A1
(43) Pub. Date: May 22, 2003

(54) Battery pack and cordless power tool using the same as power source

(75) Inventors: Nobuhiro Takano, Hitachinaka-shi (JP); Hidekazu Harada, Hitachinaka-shi (JP)

Correspondence Address: SUGHRUE MION,PLLC, 2100 Pennsylvania Avenue, NW, Washington, DC, 20037-3213, US

(73) Assignee: HITACHI KOKI CO., LTD.

(21) Appl. No.: 10/300,911

(22) Filed: Nov. 21, 2002

(30) Foreign Application Priority Data
Nov. 21, 2001 (JP) P2001-356576

(51) Int. Cl. H01M 10/48

(52) U.S. Cl. 429/90; 429/61

(57) ABSTRACT

To prevent a battery from being over-discharged and to thus improve a cycle life of the battery, a microcomputer electrically interrupts connection between the battery and a cordless power tool to compulsorily stop driving the tool when the battery voltage has become equal to or fallen below a first predetermined value. Also, to enable an operator to know that the battery is in a near over-discharge condition, the microcomputer performs a switching control of a load current when the battery voltage is above the first predetermined voltage but has become equal to or falls below the second predetermined voltage. As a result, the rotation of the motor of the tool goes abruptly slow down or the motor rotates in an irregular fashion, whereby the operator recognizes that the battery is in a charge-need condition.

### BACKGROUND OF THE INVENTION

1. Field of the Invention

The present invention relates to a battery pack including a secondary battery used as the power source for a cordless power tool.

2. Description of the Related Art

Recently, secondary batteries, such as nickel-cadmium batteries, nickel-hydrogen batteries, and lithium-ion batteries, have increased their capacity and greatly improved charge/discharge performance when charged and discharged with large current. These high-performance secondary batteries are used as the power source of high-load machines, such as cordless power tools (referred to as simply “power tools” hereinafter). Secondary batteries used in power tools are normally in the form of a battery pack that includes a battery made from battery cells connected in series by, for example, a connection plate. The battery pack is mounted in the power tool to drive a motor for tightening screws or for performing other operations.

However, when a power tool is driven using a battery pack as the power source, the motor rotates without any substantial drop in rotation speed until the secondary battery is almost completely discharged. Once the secondary battery is totally discharged, the motor stops rotating suddenly. As a result, the operator will normally continue using the power tool until the motor stops. This can shorten the cycle life of the battery pack.

The cycle life of the battery pack is shortened because of variation in capacity of the cells that make up the battery. That is, lower capacity cells tend to overcharge and over-discharge when normal capacity cells contained in the same battery pack are properly charged and discharged, which shortens the life of the lower capacity cells compared to the other cells. Consequently, the life cycle of the battery pack overall is shortened.

FIG. 1 shows discharge characteristic of a battery and of two types of cells in the battery. Curve A represents change in voltage observed in output of a battery over time while the battery discharges. Curves B and C represent change in voltage observed over time in output from individual cells of the battery. The cell of curve B has a capacity that is equivalent to the average of all the other cells in the battery. The cell of curve C has a capacity that is lower than the average. It is assumed that the operator turns off the power tool at time S because the voltage of the battery is judged to be no longer sufficient to drive the motor of the power tool.

As the battery is discharged, voltage of the battery drops gradually until the battery is nearly empty, whereupon the voltage drops rapidly. As can be seen in the curve C, voltage of the lower capacity cell starts rapidly dropping before voltage of the cell with average capacity, and as indicated by circle D can fall below 0V before the discharge stop time S. In this case, the lower capacity cell is over-discharged condition, and is in what is referred to as a “pole reversed condition”. When a cell is in a pole reversed condition, then hydrogen gas is generated at the positive terminal of the cell and accumulates inside the cell. When charge and discharge are repeated, electrolyte can leak from the cell and the cycle life of the battery can be reduced.

In particular, when the battery pack is used in a power tool to drive a motor under a heavy load, such as for tightening screws, the cycle life of a secondary battery can be shortened. This is because the battery is used up until the motor stops rotating. Typically, power tools are not provided with a function for preventing over-discharge of the battery.

### SUMMARY OF THE INVENTION

In view of the foregoing, it is an object of the present invention to overcome the above-described conventional problems and to improve the cycle life of the battery pack by enabling an operator to know that the battery is near complete discharge so that over-discharge of cells can be prevented.

According to one aspect of the invention, there is provided a battery pack including a battery, a battery voltage detector, detection means, and alerting means. The battery includes a plurality of chargeable battery cells connected in series. The battery has a first terminal connected to the positive terminal of the battery pack and a second terminal connected to the negative terminal of the battery pack. The battery voltage detector is provided for detecting a battery voltage across the first terminal and the second terminal of the battery. Based on the battery voltage detected by the battery voltage detector, the detection means detects that the battery has reached a charge-need condition. The charge-need condition indicates that the battery needs to be charged. When the charge-need condition is detected, the detection means outputs a detection signal. Responsive to the detection signal, the alerting means alerts a user to charge the battery during use of the battery as a power source for a load connected between the positive terminal and the negative terminal. The alerting means gives a physically perceivable impression to the user so that the user can recognize the charge-need condition of the battery.

Preferably, the alerting means may instruct the load to generate the physically perceivable impression. A display unit may further be provided for displaying a warning that the battery has reached the charge-need condition when the alerting means alerts the user to charge the battery.

Preferably, the alerting means may include a switching unit disposed in a current path between the first, terminal and the positive terminal or between the second terminal and the negative terminal. The switching unit performs a switching action, wherein when the switching unit is turned ON, a current is allowed to flow in the load whereas when the switching unit is turned OFF, the current is interrupted from flowing in the load. By the switching action peformed by the switching unit, an average level of the current is decreased. As a result, a reduced current will continue flowing to the load. Therefore, in the case of using the battery pack for a power tool, rotation of the power tool's motor will slow down. The operator will be able to realize from the change in the motor speed that the battery is nearly in a discharged condition, and take action to prevent an over-discharge of the battery.

The load current can be decreased by fixing the current to a low level current. In this case, the motor of the power tool will rotate at a fixed low speed. Alternatively, the load current can be decreased by cyclically changing the load current within a range that is lower than the ordinary load current level. In this case, the speed of the motor will cyclically change. In either case, the operator receives a perceptional warning that draws his or her attention to the discharged condition of the battery.

The battery voltage for determining that the battery is in the charge-need condition can be a voltage that corresponds to when the battery is near an over-discharged condition or can be a voltage that corresponds to just after an over-discharged condition is reached. When the battery voltage corresponding to the charge-need condition corresponds to a voltage directly after an over-discharged condition, it is desirable to stop flow of current to the power tool when the battery voltage is detected to have dropped to or less than a predetermined voltage.

It is desirable that the detection means detects that the battery has reached a critical condition when the battery voltage detected by the battery voltage detector has become, equal to or fallen below a first predetermined voltage and that the battery has reached a near over) discharge condition when the battery voltage detected by the battery voltage detector has become equal to or fallen below a second predetermined voltage but above the first predetermined voltage. The charge need condition includes both the near-discharge condition and the critical condition.

In this case, the switching unit may perform the switching action to decrease an average level of the current when the near over-discharge condition is detected. Also, it is desirable that the switching unit be turned OFF to stop actuation of the load when the critical condition is detected. It is desirable to provide a display unit that displays a first warning that the battery has reached the critical condition when the critical condition is detected and a second warning that the battery has reached the near over-discharge condition. Because the first display displays the first warning that the battery has reached the critical condition, which may mean a discharged condition, the operator can know that the reason the motor of the power tool has stopped rotating is because the battery is nearly empty. The display can be set to read that the battery is over-discharged when the first predetermined voltage is set to a voltage that corresponds to a voltage directly after an over-discharged condition is reached. The display can display that the battery is nearly over-discharged when the second predetermined voltage is a voltage that corresponds to the voltage of the battery when the battery is nearly over-discharged.

A battery temperature detector may further be provided for detecting a temperature of the battery. The switching unit is rendered OFF when the temperature of the battery detected by the battery temperature detector exceeds a predetermined temperature. When the battery is continuously discharged, Joule heat is generated in proportion to the duration of discharge so that the temperature of the battery increases. If the battery temperature becomes extremely high, then the electrolyte in the battery can boil. Even if the battery temperature is not high enough to boil the electrolyte, the life of the battery can be shortened by continuous use at high temperature. Therefore, there is a need to manage the temperature of the battery. With the battery temperature detector, it is judged whether or not the battery temperature is at an abnormally high temperature greater than a predetermined temperature. When the battery temperature is judged to be abnormally high, then further discharge of the battery, that is further use of the power tool, is prohibited.

According to another aspect of the invention, there is provided an electrically powered tool using the above-described battery pack as a power source.

### BRIEF DESCRIPTION OF THE DRAWINGS

The above and other objects, features and advantages of the invention will become more apparent from reading the following description of the embodiment taken in connection with the accompanying drawings in which:

FIG. 1 is a graph showing discharge characteristic of a conventional battery;

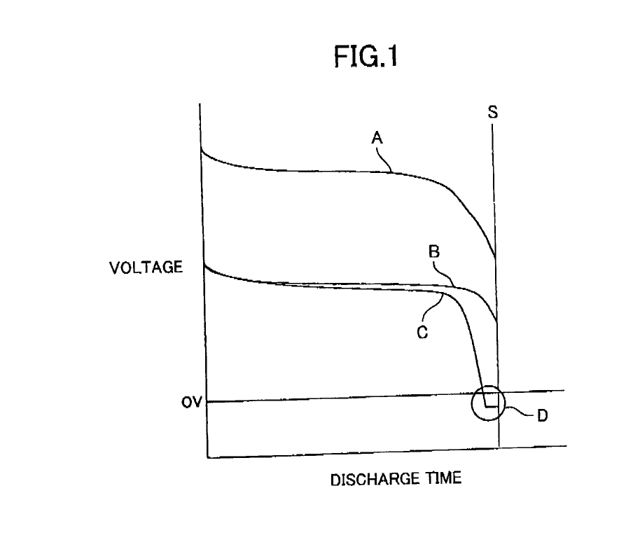

FIG. 2 is a circuit diagram showing a battery pack according to an embodiment of the present invention connected to a power tool; and

FIG. 3 is a flowchart representing operations performed by a control unit of the battery pack of FIG. 2.

### DETAILED DESCRIPTION OF THE EMBODIMENT

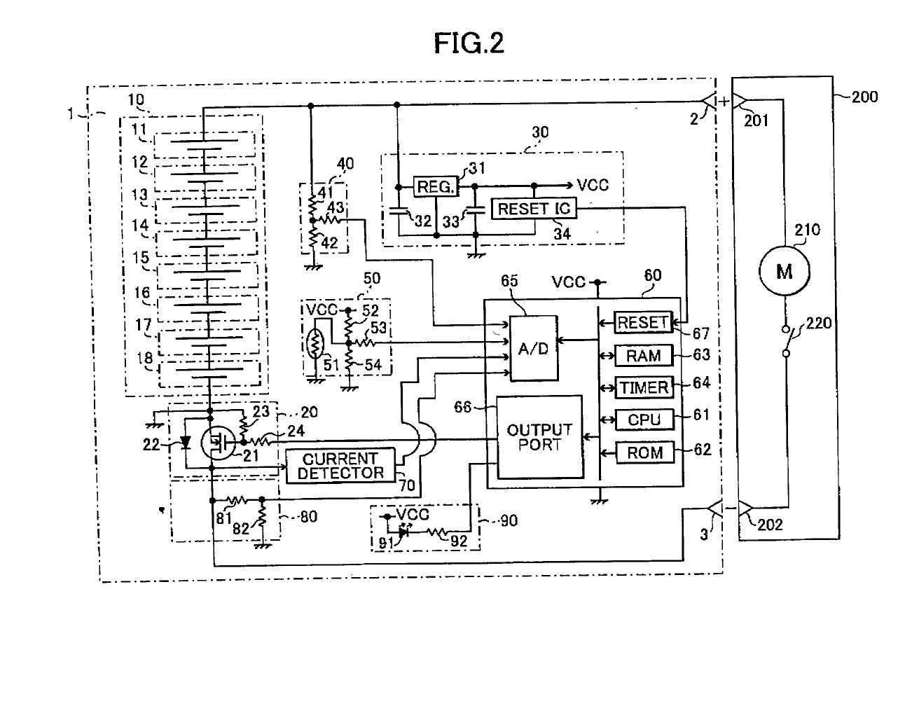

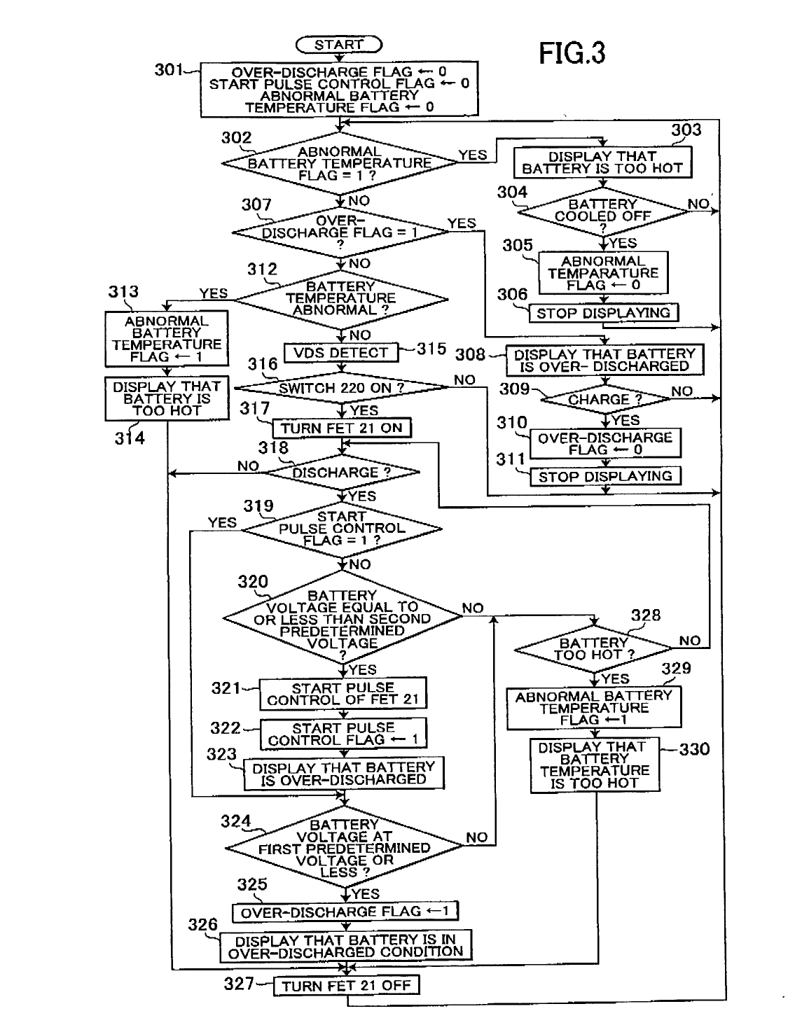

Next, a battery pack 1 according to an embodiment of the present invention will be described with reference to FIGS. 2 and 3. FIG. 2 is a circuit diagram showing the battery pack 1 connected to a power tool 200. The battery pack 1 has a positive terminal 2 and a negative terminal 3. The positive terminal 2 is connected to a positive terminal 201 of the power tool 200 and the negative terminal 3 is connected to a negative terminal 202 of the power tool 200. A DC motor 210 and a switch 220 are connected in series between the positive terminal 201 and the negative terminal 202 of the power tool 200.

The battery pack 1 includes a battery 10, a switching portion 20, a constant voltage power source 30, a battery voltage detector 40, a battery temperature detector 50, a microcomputer 60, a current detector 70, a trigger detector 80, and a display 90.

The battery 10 includes cells 11-18 that are connected in series by connection plates. The cells of the battery 10 are supposed to have the same capacity. However, in actuality the cells 11-18 have some variation in capacity.

When the switch 220 of the power tool 200 is turned on while the battery pack 1 is connected to the power tool 200, a discharge current flows from the positive terminal of the battery 10 through the power tool 200 to the negative terminal of the battery 10. The battery voltage detector 40, the constant voltage power source 30, the trigger detector 80, and the switching portion 20 are connected to the discharge current path, and the microcomputer 60 is connected to these and other components contained in the battery pack 1.

The microcomputer 60 includes a central processing unit (CPU) 61, a read-only memory (ROM) 62, a random access memory (RAM) 63, a timer 64, an analog-to-digital (A/D) converter 65, an output port 66, and a reset input port 67. The components of the microcomputer 60 are connected to each other through an internal bus.

The switching portion 20 is connected between the negative terminal of the battery 10 and the negative terminal 3 of the battery pack 1, and includes a field-effect transistor (FET) 21, and resistors 23, 24. A control signal from the output port 66 of the microcomputer 60 is applied to the gate of the FET 21 via the resistor 24 to perform switching control for the load current flowing through the power tool 200. A diode 22 connected across the source and drain of the FET 21 serves as a charge current path in which a charge current flows while the battery 10 is being charged with a battery charger (not shown) connected to the battery pack 1 in place of the power tool 200.

The current detector 70 serves to judge whether the battery 10 is being charged, discharging, or in other conditions, such as when no load is being placed on the battery. The input of the current detector 70 is connected to the cathode of the diode 22 and to the drain of the FET 21. The output of the current detector 70 is connected to the A/D converter 65 of the microcomputer 60.

Although not shown, the current detector 70 includes an inverting amplifier circuit and a non-inverting amplifier connected in parallel which selectively amplify the voltage applied to the current detector 70. The polarity of the voltage applied to the current detector 70 is determined depending on the direction of current, that is, whether a charge current flowing in the diode 22 or a discharge current flowing in the FET 21. The level of the voltage applied to the current detector 70 is determined depending on an ON resistance of the FET 21 and an ON voltage of the diode 22. As a result, an output is generated by either the inverting amplifier circuit or the non-inverting amplifier circuit depending on whether the battery 10 is being charged or discharged. The output from the current detector 70 is subject to A/D conversion by the A/D converter 65 of the microcomputer 60. If it is desired to accurately detect the current value during charge and discharge, then a low-resistance current detecting resistor can be disposed in the loop followed by the current. In this case, the voltage developed according to the level of the current flowing through the resistor can be amplified by an operational amplifier. The AID converter 65 performs an A/D conversion on the output from the operation amplifier and the current value is calculated based on the resultant digital output.

The constant voltage power source 30 includes a three-terminal regulator (REG.) 31, smoothing capacitors 32, 33, and a reset IC 34. The constant voltage V_{cc} output from the constant voltage power source 30 serves as the power source for the battery temperature detector 50, the microcomputer 60, the current detector 70, and the display 90. The reset IC 34 is connected to a reset input port 67 of the microcomputer 60 and outputs a reset signal to the reset input port 67 in order to initialize settings in the microcomputer 60.

The battery voltage detector 40 is provided for detecting a voltage of the battery 10 and includes resistors 41 to 43. The resistors 41, 42 are connected in series between the positive terminal of the battery 10 and ground. The A/D converter 65 of the microcomputer 60 is connected, through the resistor 43, to the connection point where the resistors 41, 42 are connected together, and outputs a digital value that corresponds to the detected battery voltage. The CPU 61 of the microcomputer 60 compares the digital value from the A/D converter 65 with first and second predetermined voltages to be described later. The first and second predetermined voltages are stored in the ROM 62 of the microcomputer 60.

The battery temperature detector 50 is located adjacent to the battery 10 to detect temperature of the battery 10. The temperature detected by the battery temperature detector 50 is not the temperature of the battery 10 in a strict sense but is substantially equal to the temperature of the battery 10. The battery temperature detector 50 includes a thermistor 51 and resistors 52 to 54. The thermistor 51 is connected to the A/D converter 65 of the microcomputer 60 through the resistor 53. Accordingly, the A/D converter 65 outputs a digital value that corresponds to the battery temperature detected by the battery temperature detector 50. The CPU 61 of the microcomputer 60 compares the digital value with a predetermined value to judge whether the battery temperature is abnormally high.

The trigger detector 80 includes resistors 81, 82 and detects when the switch 220 of the power tool 200 is turned ON. While the switch 220 is OFF, the voltage of the battery 10 is not applied to the drain of the FET 21. Therefore, the input of the A/D converter 65 connected to the trigger detector 80 is held at ground potential. On the other hand, because the DC resistance of the DC motor 210 is extremely small, for example, only a few ohms, a voltage substantially the same as the battery voltage is developed between the drain and the source of the FET 21 while the switch 220 is ON. This voltage is divided at the resistors 81, 82 and the voltage developed across the resistor 82 is applied to the A/D converter 65 so that the ON condition of the switch 220 can be detected.

The display 90 includes a light emitting diode (LED) 91 and a resistor 92. The LED 91 is controlled to illuminate or turn OFF in accordance with output from the output port 66 of the microcomputer 60. The display 90 is controlled to display, for example, a warning that the temperature of the battery 10 is too high when the battery temperature detector 50 detects a battery temperature that is higher than the predetermined temperature.

Next, operation of the battery pack 1 will be described with reference to the circuit diagram of FIG. 2 and the flowchart of FIG. 3.

First, in S301 the microcomputer 60 initializes settings at its output port 66 and also initializes to zero its over-discharge flag, start pulse control flag, and abnormal battery temperature flag. The over-discharge flag indicates that the battery 10 is over-discharged. The start pulse control flag indicates that the battery 10 is nearly over-discharged. The abnormal battery temperature flag indicates that the battery temperature is abnormally high.

In S302, the microcomputer 60 judges whether the abnormal battery temperature flag is set to one. As will be described later, if the battery temperature has reached, for example, 80° C., then the microcomputer 60 judges that the battery 10 has reached an abnormally high temperature. The battery 10 generates Joule heat in proportion to the discharge time. Depending on when and for how long the battery 10 was last used, the battery 10 can already be at an abnormally high temperature at the start of a new use. The life of the battery 10 can be reduced if the battery 10 is used while at an abnormally high temperature. Therefore, the battery 10 should not be used until it cools down.

If the abnormal battery temperature flag is judged to be set to one (S302:YES), this means that the temperature of the battery 10 is abnormally high. Therefore, in S303 the display 90 is controlled to display that the battery 10 is too hot. Then, in S304, it is judged based on the output from the battery temperature detector 50, whether or not the battery 10 has cooled down to a predetermined temperature. If the battery 10 has not cooled down (S304:NO), then the program returns to S302 until the battery temperature drops sufficiently. Once the battery temperature cools to the predetermined temperature (S304:YES), then the abnormal battery temperature flag is reset to zero in S305. Then, in S306 the display 90 is controlled to stop displaying that the battery is too hot, whereupon the program returns to S302.

When it is judged in S302 that the abnormal battery temperature flag is not set to one (S302:NO), that is, when the battery 10 is not too hot, then in S307 it is judged whether or not the over-discharge flag is set to one. The over-discharge flag indicates whether or not the battery 10 is over-discharged, and indicates the battery 10 is over-discharged when set to one and not over-discharged when set to zero. When it is judged that the over-discharge flag is set to one (S307:YES), then in S308 the display 90 follows the output from the output port 66 and displays that the battery 10 is over-discharged. This urges the user to charge the battery 10.

Next, in S309 it is judged whether or not the battery 10 is charged. Because the over-discharge flag is set with a value of one as judged in S307, the battery 10 cannot be used until the battery 10 has been charged. The judgment of whether or not the battery 10 is charged is made based on the direction of current flowing through the battery 10. That is, charge current flows from the negative terminal to the positive terminal of the battery 10 through the diode 22. Therefore, whether or not the battery 10 is being charged is judged according to the direction of the current detected by the current detector 70. The program proceeds to S310 once it is judged in S309 that charging has continued for a fixed period of time (S309:YES). It should be noted that the battery 10 is charged by removing the battery pack 1 from the power tool 200 and connecting it to a separate battery charger (not shown).

If it is judged that the battery 10 has not yet been fully charged (S309:NO), then the program returns to S302 until charging is completed. Once it is judged that the battery 10 has been completely charged (S309:YES), then in S310 the over-discharge flag is reset to zero and in S311 the display 90 is controlled to stop displaying that the battery 10 is over-discharged, whereupon the program returns to S302.

When the over-discharge flag is not set to one (S307:NO), then in S312 it is judged, based on the output from the battery temperature detector 50, whether the battery temperature is abnormally high. If the battery temperature exceeds, for example, 80° C., and so is too hot, then the abnormal battery temperature flag is set to one in S313 and, in accordance with output from the output port 66, the display 90 displays that the battery 10 is too hot in S314. In this case, in S327 the FET 21 of the switching portion 20 is turned OFF in accordance with output from the output port 66, whereupon the program returns to S302.

If it is judged that the battery 10 is not too hot (S312:NO), then in S315 the voltage V_{DS} between the drain and source, of the FET 21 of the switching portion 20 is detected. Next, in S316 it is judged whether or not the switch 220 of the power tool 200 is ON based on the output from the trigger detector 80. A voltage substantially equal to the battery voltage is developed between the drain and the source of the FET 21 when the switch 220 is turned ON. Therefore, whether or not the switch 220 is turned ON can be detected based on the voltage V_{DS} detected in S315.

When the switch 220 is not turned ON (S316:NO), then the program returns to S302. If the switch 220 is turned ON (S316:YES), then in s317 the FET 21 of the switching portion 20 is turned ON in accordance with output from the output port 66. Then, whether the battery 10 is discharging is judged in S318 based on output from the current detector 70. If the battery 10 is not discharging (S318:NO), then in S327 the FET 21 of the switching portion 20 is turned OFF in accordance with output from the output port 66, whereupon the program returns to S302.

If the battery 10 is discharging (S318:YES), then in S319 it is judged whether or not the start pulse control flag is set to one. If the start pulse control flag is set to one (S319:YES), then the program jumps to the process of S324.

If the start pulse control flag is not set to one (S319:NO), then in S320 it is judged, based on output from the battery voltage detector 40, whether or not the voltage of the battery 10 has reached the second predetermined value or lower. In the present embodiment, whether or not battery voltage is at or lower than the second predetermined value is to know whether or not the battery 10 is near an over-discharged condition. The battery voltage that indicates that the battery 10 is near an over-discharged condition differs depending on the level of the discharge current. In the case of a battery used in a power tool, a near over-discharged condition can be said when the voltage of a nickel-cadmium or nickel-hydrogen battery cell falls to about 0.9V to 1.0 V, and when the battery voltage of a 3.6V lithium-ion battery cell falls to 2.5V to 2.7V. In the present embodiment, the battery 10 is a nickel-cadmium or nickel-hydrogen battery with 10 cells, so the battery voltage that indicates a near over-discharged condition is 9V to 10V.

A first predetermined voltage to be described later with respect to process in S324 serves as a reference voltage for judging whether or not the battery 10 has actually reached an over-discharged condition. Accordingly, the first predetermined voltage is lower than the second predetermined voltage. The reference for indicating that the battery 10 has reached an over-discharged condition also differs depending on the level of the discharge current. In the case of a battery used in a power tool, an over-discharged condition can be said when the voltage of a nickel-cadmium or nickel-hydrogen battery cell is about 0.8V to 0.9V, and when the battery voltage of a 3.6V lithium-ion battery cell is 2.3V to 2.5V. The first predetermined voltage is set based on these values.

When the voltage of the battery 10 is not the second predetermined voltage or lower (S320:NO), this means that battery discharge can continue without damaging the battery 10. Therefore, in S328 it is judged, based on the output from the battery temperature detector 50, whether the battery 10 is too hot. The judgment of S328 is performed in the same way as described for S312. When the battery 10 is too hot (S328:YES), then the abnormal temperature flag is set to one in S329 and, in accordance with output from the output port 66, the display 90 displays that the battery is too hot in S330. Then, in S327 the FET 21 of the switching portion 20 is turned OFF in accordance with output from the output port 66, whereupon the program returns to S302. If the battery temperature is not abnormally high (S328:NO), then the program returns to S318.

If it is judged that the voltage of the battery 10 is equal to or less than the second predetermined voltage (S320:YES), then this means that the battery 10 is nearly in an over-discharged condition. Therefore, in S321 a pulse control is started, in accordance with output from the output port 66, to perform switching action of the FET 21 of the switching portion 20 at a predetermined frequency. When the pulse control is started, an average voltage applied to the DC motor 210 drops so that the DC motor 210 rotates at a slower speed. The operator of the power tool 200 can perceive the change in speed of the DC motor 210 and understands that it means that the battery 10 has nearly reached an over-discharged condition.

After the pulse control has started in S321, the start pulse control flag is set to one in S322. Then, in S323 the display 90 is controlled by the output of the output port 66 to display that the battery is nearly over-discharged. The operator of the power tool 200 can view the display 90 to confirm that the reason the DC motor 210 is rotating more slowly is because the battery 10 is nearly used up. Then, in S324, it is judged, based on the output from the battery voltage detector 40, whether or not the voltage across the battery 10 has reached the first predetermined voltage or less. If the voltage across the battery 10 is not at the first predetermined voltage or less (S324:NO), then the program jumps to S328.

If the voltage across the battery 10 is at the first predetermined voltage or less (S324:YES), then it is judged that the battery 10 has entered an over-discharged condition. Therefore, the battery over-discharge flag is set to one in S325 and, in accordance with output from the output port 66, the display 90 is displayed to indicate a battery over-discharge condition in S326. Next, the FET 21 of the switching portion 20 is turned OFF in S327, whereupon the program returns to S302.

While the invention has been described in detail with reference to specific embodiments thereof, it would be apparent to those skilled in the art that various changes and modifications may be made therein without departing from the spirit of the invention, the scope of which is defined by the attached claims.

For example, the embodiment describes that when the battery voltage is at the second predetermined voltage or less during use of the power tool 200, the switching portion 20 is controlled to compulsorily lower the speed of the DC motor 210 (first control). Further, when the battery voltage is lower than the second predetermined voltage and also equal to or lower than the first predetermined voltage, then the switching portion 20 is controlled to cut off load current supplied to the DC motor 210 (second control).

However, the above-described embodiment may be modified in such a manner that the first control is dispensed with and only the second control is performed (first modification). The embodiment may alternatively be modified in such a manner that the second control is dispensed with and only the first control performed (second modification). When the second modification is implemented, then after the battery voltage has reached the first predetermined voltage or lower, the speed of the DC motor 210 should be reduced to a level where the operator can no longer use the power tool 200. This urges the operator to charge the battery 10 and also prevents the battery 10 from being over-discharged by continued use of the power tool 200. Also, when implementing the second modification, the first predetermined voltage can be set to a voltage corresponding to a near over-discharged condition of the battery 10, and not set to a voltage corresponding to an over-discharged condition.

A large instantaneous current flows when a DC motor is started. This results in an instantaneous drop in battery voltage. Therefore, although not indicated in the flowchart of FIG. 3, the judgment made in S320 and S324 for determining battery voltage during use needs to take time into consideration.

The display operation of S314 and S330 for indicating that the battery 10 is too hot, the display operation of S323 for indicating that the battery is nearly over-discharged, and the display operation of S326 for indicating that the battery 10 is in a battery over-discharge condition, can be performed by turning the LED 91 ON and OFF at frequencies that correspond to the different conditions to be indicated. Alternatively, a plurality of LEDs (not shown in the circuit diagram of FIG. 2) can be provided in an array for displaying messages and the like that correspond to these different conditions.

The embodiment describes that the switching portion 20 is connected between the negative terminal of the battery 10 and the negative terminal 3 of the battery pack 1. However, the switching portion 20 can be connected between the positive terminal of the battery 10 and the positive terminal 2 of the battery pack 1.

What is claimed is:

1. A battery pack having a positive terminal and a negative terminal, comprising:
a battery including a plurality of chargeable battery cells connected in series, the battery having a first terminal connected to the positive terminal and a second terminal connected to the negative terminal;
a battery voltage detector for detecting a battery voltage across the first terminal and the second terminal of the battery;
detection means for detecting, based on the battery voltage detected by the battery voltage detector, that the battery has reached a charge-need condition indicating that the battery needs to be charged, the detection means outputting a detection signal when the charge-need condition is detected; and
alerting means, responsive to the detection signal, for alerting a user to charge the battery during use of the battery as a power source for a load connected between the positive terminal and the negative terminal, the alerting means giving a physically perceivable impression to the user so that the user can recognize the charge-need condition of the battery.

2. The battery pack according to claim 1, wherein the alerting means instructs the load to generate the physically perceivable impression.

3. The battery pack according to claim 2, further comprising a display unit that displays a warning that the battery has reached the charge-need condition when the alerting means alerts the user to charge the battery.

4. The battery pack according to claim 2, wherein the alerting means comprises a switching unit disposed in a current path between the first terminal and the positive terminal or between the second terminal and the negative terminal, for performing a switching action, wherein when the switching unit is turned ON, a current is allowed to flow in the load whereas when the switching unit is turned OFF, the current is interrupted from flowing in the load.

5. The battery pack according to claim 4, wherein the switching unit performs the switching action to decrease an average level of the current.

6. The battery pack according to claim 4, wherein the switching unit is turned OFF to stop actuation of the load.

7. The battery pack according to claim 1, wherein the detection means detects that the battery has reached a critical condition when the battery voltage detected by the battery voltage detector has become equal to or fallen below a first predetermined voltage and that the battery has reached a near over-discharge condition when the battery voltage detected by the battery voltage detector has become equal to or fallen below a second predetermined voltage but above the first predetermined voltage, the charge need condition including both the near-discharge condition and the critical condition.

8. The battery pack according to claim 7, wherein the alerting means comprises a switching unit disposed in a current path between the first terminal and the positive terminal or between the second terminal and the negative terminal, for performing a switching action, wherein when the switching unit is turned ON, a current is allowed to flow in the load whereas when the switching unit is turned OFF, the current is interrupted from flowing in the load, the switching unit performing the switching action to decrease an average level of the current when the near over-discharge condition is detected by the detection means and the switching unit being turned OFF to stop actuation of the load when the critical condition is detected by the detection means.

9. The battery pack according to claim 8, further comprising a display unit that displays a first warning that the battery has reached the critical condition when the critical condition is detected by the detection means and a second warning that the battery has reached the near over-discharge condition when the near over-discharge condition is detected by the detection means.

10. The battery pack according to claim 8, further comprising a battery temperature detector for detecting a temperature of the battery, the switching unit being rendered OFF when the temperature of the battery detected by the battery temperature detector exceeds a predetermined temperature.

11. An electrically powered tool comprising:
a motor having a first positive terminal and a first negative terminal;
a battery including a plurality of chargeable battery cells connected in series, the battery having a second positive terminal connected to the first positive terminal and a second negative terminal connected to the first negative terminal, the battery serving as a power source for the motor;
a battery voltage detector for detecting a battery voltage across the second positive terminal and the second negative terminal;
detection means for detecting, based on the battery voltage detected by the battery voltage detector, that the battery has reached a charge-need condition indicating that the battery needs to be charged, the detection means outputting a detection signal when the charge-need condition is detected; and
alerting means, responsive to the detection signal, for alerting a user to charge the battery, the alerting means giving a physically perceivable impression to the user so that the user can recognize the charge-need condition of the battery.

12. The electrically powered tool according to claim 11, wherein the alerting means instructs the motor to generate the physically perceivable impression.

13. The electrically powered tool according to claim 12, further comprising a display unit that displays a warning that the battery has reached the charge-need condition when the alerting means alerts the user to charge the battery.

14. The electrically powered tool according to claim 12, wherein the alerting means comprises a switching unit disposed in a current path between the first positive terminal and the second positive terminal or between the first negative terminal and the second negative terminal, for performing a switching action, wherein when the switching unit is turned ON, a current is allowed to flow in the motor whereas when the switching unit is turned OFF, the current is interrupted from flowing in the motor.

15. The electrically powered tool according to claim 14, wherein the switching unit performs the switching action to decrease an average level of the current.

16. The electrically powered tool according to claim 14, wherein the switching unit is turned OFF to stop rotations of the motor.

17. The electrically powered tool according to claim 10, wherein the detection means detects that the battery has reached a critical condition when the battery voltage detected by the battery voltage detector has become equal to or fallen below a first predetermined voltage and that the battery has reached a near over-discharge condition when the battery voltage detected by the battery voltage detector has become equal to or fallen below a second predetermined voltage but above the first predetermined voltage, the charge need condition including both the near-discharge condition and the critical condition.

18. The electrically powered tool according to claim 17, wherein the alerting means comprises a switching unit disposed in a current path between the first positive terminal and the second positive terminal or between the first negative terminal and the second negative terminal, for performing a switching action, wherein when the switching unit is turned ON, a current is allowed to flow in the motor whereas when the switching unit is turned OFF, the current is interrupted from flowing in the motor, the switching unit performing the switching action to decrease an average level of the current when the near over-discharge condition is detected by the detection means and the switching unit being turned OFF to stop rotations of the motor when the critical condition is detected by the detection means.

19. The electrically powered tool according to claim 18, further comprising a display unit that displays a first warning that the battery has reached the critical condition when the critical condition is detected by the detection means and a second warning that the battery has reached the near over-discharge condition when the near over-discharge condition is detected by the detection means.

20. The electrically powered tool according to claim 18, further comprising a battery temperature detector for detecting a temperature of the battery, the switching unit being rendered OFF when the temperature of the battery detected by the battery temperature detector exceeds a predetermined temperature.
